(19) United States
(12) Patent Application Publication
(10) Pub. No.: US 2023/0000073 A1
(43) Pub. Date: Jan. 5, 2023

(54) A COMPOSITION FOR ACTIVATING PLANT'S NATURAL DEFENSE MECHANISMS TO EXTEND THE SHELF LIFE AND METHODS THEREOF

(71) Applicant: GREENPOD LABS PRIVATE LIMITED, Chennai (IN)

(72) Inventor: Deepak Kumar DURAIVELU RAJMOHAN, Chennai (IN)

(21) Appl. No.: 17/778,109

(22) PCT Filed: Dec. 20, 2020
(86) PCT No.: PCT/IN2020/051037

§ 371 Date: May 19, 2022

(30) Foreign Application Priority Data
Dec. 23, 2019 (IN) 201941053417

(51) Int. Cl. A01N 3/00; A01N 3/02; A23B 7/154; A23L 3/3499; B65D 81/28

(52) U.S. Cl. CPC A01N 3/00; A01N 3/02; A23B 7/154; A23L 3/3499; B65D 81/28; A23V 2002/00

(57) ABSTRACT

The invention provides a composition and smart packaging methods for extending the shelf life of the agricultural produces. The composition comprising active ingredients, which act as a signal molecule to activate a defense mechanism with a flower, greens, fruit, or vegetable. The product is designed in the desired form (like sachet, Spray, crate, covering paper, etc.), which includes the encapsulated powder of the active ingredient which is released in a sustained manner near the farm/agricultural produce. When the volatile active ingredient is released it slows down the ethylene biosynthesis pathway and restricts microbial growth of fresh produce without any expensive technologies (refrigeration) and harmful chemicals (toxic). It can be adopted to any stage of the fruits and vegetable supply chain.

### FIELD OF INVENTION

This invention is related to the food industry. Particularly provides a composition for activating the plant's natural defense mechanisms to extend the shelf life and methods thereof, as a post-harvest solution to minimize the huge post-harvest losses of flowers, fruits, and vegetables by extending its shelf life.

### BACKGROUND OF THIS INVENTION

India being the largest producer of flowers, fruits, and vegetables, the processing percent in the country is less than three percent. Additionally, the massive unorganized sector of fresh farm and agricultural produce holds more than 70% of the business. Inadequacy in post-harvest management leads to quality loss and microbial spoilage in fresh produce. The post-harvest losses of fruits & vegetables are estimated to cost Rs. 40,811 crores per year (2016).

Salicylic acid (SA) and jasmonic acid (JA) were applied to the fruits as a post-harvest dip treatment followed by wound inoculation with the pathogens. Salicylic (SA) and jasmonic (JA) acids are natural disease resistance inducers that stimulate antifungal activity against various pathogens of fruit crops such as mango, pear, and citrus fruits (Shaat and Galal, 2004). In addition to inducing resistance in plants, SA and JA also play key roles in the regulation of plant growth and development. In addition to inducing resistance in plants, SA and JA also play key roles in the regulation of plant growth and development (Meena et al., 2001).

Post-harvest Treatments with Methyl Jasmonate and Salicylic Acid for Maintaining Physico-Chemical Characteristics and Sensory Quality Properties of Apricot Fruit during Cold Storage and Shelf-Life [Raskin, 1992; Turner et al., 2002]. MeJA was defined as a natural plant growth regulator and was found to be active in many physiological systems [e.g. Turner et al., 2002].

Resistance induced to disease in plants by biotic and abiotic elicitors is a very effective method for restricting the spread of fungal infection. In general, pathogen resistance processes in plants are based on their own defense mechanisms, such as pre-existing antimicrobial compounds and inducible defense mechanisms. The signal molecules salicylic acid (SA), jasmonic acid (JA), and methyl jasmonate (MeJA) are endogenous plant growth substances that play key roles in development and responses to environmental stresses. These signal molecules are involved in some signal transduction systems in plants and fruits, which induce particular enzymes catalyzing biosynthetic reactions to form defense compounds such as polyphenols, alkaloids, or pathogenesis-related (PR) proteins. This can result in the induction of defense responses and provide protection for plants and fruits from pathogen attack. Salicylic acid activates induction of acquired systemic resistance (SAR) response in plants, proving that in the plant-microorganism interaction, the enzyme phenylalanine ammonia lyase (PAL) is induced, which is the key in the biosynthesis of phenolic compounds. SA regulates activities of enzymes, peroxidase (POD), and polyphenol oxidase (PPO), that is related to the induced defense of plants and fruits against biotic and abiotic stress.

Chilling alleviating in fruits and vegetables treated with salicylates and jasmonates could be attributed to;

(1) Enhancing membrane integrity by reducing phos-pholipase D and C (PLD and PLC) and lipoxygenase (LOX) enzymes activities, enhancing unsaturated fatty acids/saturated fatty acids (unSFA/SFA) ratio probably through an increase of fatty acid desaturases (FAD) gene expression and maintaining energy status, ATP and adenylate energy charge (AEC).
(2) Enhancing heat shock proteins (HSPs) gene expression and accumulation.
(3) Enhancing antioxidant system activity.
(4) Enhancing arginine pathways which led to an accumulation of signaling molecules with pivotal roles in improving chilling tolerance such as polyamines, nitric oxide, proline, and_-aminobutyric acid (GABA).
(5) Activation of the C-repeat binding factor (CBF) pathway and
(6) alteration in phenylalanine ammonia-lyase (PAL) and polyphenol oxidase (PPO) enzymes activities.

MeJa and MeSa have been described as signal molecules in plant stress responses, both biotic and abiotic types, including wounding, pathogens/insects, mechanical, drought, and chilling injury (CI), among others (Creelman & Mullet, 1995; Hayat & Ahmad, 2007).

Salicylic acid (2-hydroxybenzoic acid, C7H603), a phenolic compound, natural growth regulator, and antioxidant in vascular plants [12] stimulates many physiological processes that control plant growth and development such as nutrients uptake, membrane permeability, enzymes activity, and disease-resistance mechanisms [13]. Salicylic acid improves fruit quality and storability and has a toxicity effect on fungi during storage. In addition, it can delay fruit ripening, probably through inhibition of ethylene biosynthesis.

Salicylic acid (SA) and methyl salicylate (MeSA) are endogenous signal molecules, playing pivotal roles in regulating stress responses and plant developmental processes including heat production or thermogenesis, photosynthesis, stomatal conductance, transpiration, ion uptake, and transport, disease resistance, seed germination, sex polarization, crop yield and glycolysis (Klessig & Malamy, 1994). MeSA triggers disease resistance and mediates the expression of defense related genes in neighbouring plants and the healthy tissue of infected plants (Shulaev, Silverman, & Raskin, 1997).

TABLE 1
Summary of some effects of SA on some harvested horicultural crops reported by different authors

| Author(s) | Reported results | Co [symbol] |
|---|---|---|
| K [symbol] et al. (2007) | Ma [symbol] retention, decrease in ethylene production & fungal decay | Strawberry |
| S [symbol] , [symbol] , Kal [symbol] | Inhibition of PAI, activity, retention of | Pomegranate |
| Serrano, and Valero | vitamin C content reduction of [symbol] | |
| (2009) | | |
| Zhang et al. (2003) | Inhibition of ACS, ACO & LO [symbol] activity, suppression of ethylene & | Kiwifruit |
| | supe [symbol] free radical production, increase in total SA content. | |
| [symbol] and Dwi [symbol] (2000) | Decrease in fruit softening pulp/peel ratio, reducing sugar content, | Banana |
| | [symbol] activity & [symbol] rate, inhibition of cellulase, | |
| | P [symbol] , xyl [symbol] CAT & POX activity | |
| Wang, Chen, Kong, Li. | Increase in [symbol] , APX, GR activity [symbol] ratios decrease in | Peach |
| and Ar [symbol] (2206) | [symbol] induction of HSP101 & HSP73 genes | |
| Yao and Tian (200 [symbol] ) | Increase in [symbol] , 3-gluc [symbol] , PA [symbol] & | Sweet cherry |
| | [symbol] activity, induction of disease resistance, | |
| | direct antifungal activity | |
| Fung et al. (2004) | Increase in transcript levels of AOX, [symbol] | Sweet pepper |
| Ding and Wang (2003) | Development of red color, regulation of ACS genes expression | Tomato |
| Ding et al. (2001) | Accumulation of HSPs, [symbol] reduction | Tomato |
| Hung, Li [symbol] | Acceleration of H₂O₂ acculation, increase in | Orange |
| and Xia (2007) | SOD, GR, APX & DHAR activity & ASA/DHASA | |
| | & GSH/GSSG [symbol] decrease in lipid [symbol] & MDA | |
| [symbol] | Decreased ethylene, LOX activity, MDA content, DI, | Apple |
| | softening, & [symbol] rates. [symbol] activated the SOD, POD, CAT [symbol] enzymes | |
| [symbol] et al. (2009) | Inhibition of ethylene production, ripening & | Kiwifruit |
| | decay control | |
| Fung et al. (2006) | Expression of [symbol] resistance | Tomato |
| Xu and [symbol] | Decay control increase in CAT, GPX, [symbol] | Sweet cherry |
| [symbol] and Zhang (2008) | Increase in GPX, APX, CAT, SOD & GR activity, | Watermelon |
| | induction of resistance to [symbol] | |
| Yu and [symbol] | Enchaned the biological efficacy of antagonist | Apple |
| | [symbol] | |
| [symbol] (2010) | Decay, Ripenings, weight loss reduction | Strawberry |
| Cao, Zeng, and [symbol] (2006) | Inhibiton of PAL, CAT & POD decrease in superoxide | [symbol] |
| | free radical production & [symbol] | |
| Ca [symbol] et al. (2006) | Induction of resistance todiseases, increase in | [symbol] |
| | POD, PAL, GR, [symbol] decrease in CAT & APX | |
| [symbol] (2006) | Delayed discoloration, maintained edible quality | Fresh-cut |
| | activity of PPO, POD & [symbol] . | Chestnut |

DI = decay index, GR = glutathione reductase, GSSG = oxidized glutathione, GSH = reduced glutathione, DHAR = dehydro [symbol] , [symbol] = ascorbate, DHA [symbol] dehydro [symbol] , MDA = Ma [symbol] [symbol]
indicates data missing or illegible when filed

Plants protect themselves against pathogen attacks by activating some kinds of defense mechanisms such as local acquired resistance (LAR) and systemic acquired resistance (SAR). As seen in FIG. 1, salicylates are a major component in the signal transduction pathways of plants playing an important role in disease resistance (Park, Kaimoyo, Kumar, Mosher, & Klessig, 2007).

In CN103083209B, Master slice for mouthwash and preparation method thereof discloses functional ingredients and a forming accessory, wherein the forming accessory comprises a filling agent, an effervescing agent, an adhesive, a disintegrating agent, a flavoring agent, and a lubricating agent, and when the functional raw materials are oil substances, the raw materials are coated by employing beta-cyclodextrin to form the oily functional beta-cyclodextrin inclusion compound. The master slice for mouthwash can be disintegrated in warm water below 50 DEG C within two minutes, and the disintegrated aqueous solution can be used for rinsing the teeth; and moreover, the advantages of toothpaste, chewing gum, mouthwash, and other conventional mouth care products are integrated by the master slice for mouthwash, and the disadvantages are eliminated. But beta cyclodextrin is used for a different purpose and no combination is disclosed for protecting any agricultural produce.

Similarly, in U.S. Pat. No. 6,942,848B2, Oral rinse and dentifrice compositions, comprising a phenolic selected from the group consisting of menthol, eucalyptol, methyl salicylate, thymol, triclosan, and mixtures thereof; and a cyclodextrin selected from the group consisting of hydroxypropyl β-cyclodextrin, hydroxyethyl β-cyclodextrin, hydroxypropyl γ-cyclodextrin, hydroxyethyl γ-cyclodextrin, α-cyclodextrin methyl β-cyclodextrin, and mixtures thereof. These compositions are useful in retarding the development of plaque, treating gingivitis, and in treating the presence of micro-organisms in the oral cavity and not in agricultural produces.

Hence there is a need for proper method and composition to extend the shelf life of the Agricultural produce. This invention is providing the simplest method and Composition for extending the shelf life of the produce.

### OBJECTIVE OF THIS INVENTION

The principal objective of this invention is to provide a composition for activating a plant's natural defense mechanisms to extend its shelf life and methods thereof.

### BRIEF DESCRIPTION OF DRAWINGS

FIG. 1: depicts the flow chart of the process.

FIG. 2: depicts the colour index for Fig fruit

FIG. 3: depicts comparative shelf life of normal Fig with DIP coated

FIG. 4: depicts comparative shelf life of normal Fig with Sachet protected

FIG. 5: depicts the position of the Sachet once placed on the lid. The box is 90% closed to ensure the right air flow

FIG. 6: depicts fig fruit shelf extension using sachet form.

FIG. 7: depicts the fig fruit shelf extension using DIP coating.

FIG. 8: Colour index for Pomegranate Fruit

FIG. 9: depicts comparative shelf life of normal Pomegranate with DIP coated

FIG. 10: depicts comparative shelf life of normal Pomegranate with Sachet protected

FIG. 11: graphical illustration of shelf life extension in pomegranates,

FIG. 12: depicts a table of results obtained from Pomegranate shelf life.

FIG. 13: depicts the comparative shelf life of tomatoes

FIG. 14: Depicts the graphical illustration of shelf life extension in tomatoes.

FIG. 15: depicts a table of results obtained in the shelf life of tomatoes

FIG. 16: depicts the effect of the composition on various fruits like Banana and Mango

FIG. 17: depicts the effect of composition on Red roses

FIG. 18: Depicts the graphical representation of results obtained for Red roses

FIG. 19: depicts the effect of composition on pink roses (paneer rose) FIG. 20: Depicts the graphical representation of results obtained for pink roses

### STATEMENT OF THIS INVENTION

The invention provides a composition and smart packaging methods for extending the shelf life of the agricultural produces. The composition comprising active ingredients, which act as a signal molecule to activate a defense mechanism with a flower, greens, fruit, or vegetable. The product is designed in the desired form (like sachet, Spray, crate, covering paper, etc.), which includes the encapsulated powder of the active ingredient which is released in a sustained manner near the farm/agricultural produce. When the volatile active ingredient is released it slows down the ethylene biosynthesis pathway and restricts microbial growth of fresh produce without any expensive technologies (refrigeration) and harmful chemicals (toxic). It can be adopted to any stage of the fruits, flowers, and vegetables supply chain.

### DETAILED DESCRIPTION OF THE INVENTION

The embodiments of the disclosure as well as a preferred mode of use, objectives, and advantages thereof, will best be understood by reference to the following detailed description of an illustrative embodiment when read in conjunction with the accompanying drawings.

Agricultural produce covers all fruits, flowers, vegetables, cereals, tubers, and any other produce that is packed and transported from one place to another and stored, during the off-season or transit phases. It not only covers food products, but also agricultural products that are used for decorative purposes like flowers.

This concept of smart packaging comprises a novel composition with active ingredients, which acts as a signal molecule to activate a defense mechanism with the agricultural produce. The product is designed in the desired form like sachet, spray, covering foil or paper, container or crates, etc., it includes the encapsulated powder of the active ingredient, which is released in a sustained manner near the agricultural produce. When the volatile active ingredient is released from the system, it slows down the ethylene biosynthesis pathway and restricts microbial growth of fresh produce without any expensive technologies (refrigeration) and harmful chemicals (toxic). It can be adopted to increase the shelf life of the flowers, fruits, and vegetable supply chain.

This product focuses mainly on the following factors,

Control of Ethylene Biosynthesis

Ethylene, a gaseous growth hormone present in many fruits & vegetables. It releases from the surface of the produces during ripening. Ripening induces the color change and tissue softening, which is acceptable until it reaches over-ripening. The over-ripened stage produces adverse biochemical changes and deteriorates the quality significantly. Ethylene released from one fruit can accelerate the ripening process of other produces and promote over-ripening subsequently deteriorating the quality.

The composition contains phenolic acids, which are edible and non-toxic. These phenolic acids act as a signal molecule which attributes to the following;
(1) Enhancing membrane integrity by reducing phospholipase D and C (PLD and PLC) and lipoxygenase (LOX) enzymes activities, enhancing unsaturated fatty acids/saturated fatty acids (unSFA/SFA) ratio probably through the increase of fatty acid desaturases (FAD) gene expression and maintaining energy status, ATP and adenylate energy charge (AEC).
(2) Enhancing heat shock proteins (HSPs) gene expression and accumulation.
(3) Enhancing antioxidant system activity.
(4) Enhancing arginine pathways led to the accumulation of signaling molecules with pivotal roles in improving chilling tolerance such as polyamines, nitric oxide, proline, and aminobutyric acid (GABA).
(5) Activation of the C-repeat binding factor (CBF) pathway, and
(6) alteration in phenylalanine ammonia-lyase (PAL) and polyphenol oxidase (PPO) enzymes activities.

Antimicrobial Effect

After harvesting, the produce starts ripening with the release of ethylene, carbon dioxide, and water. Moisture accumulation on the surface causes potential microbial growth. On the other hand, microbial contamination can happen at any stage of the fruits and vegetables supply chain.

The proprietary combination of phenolic acids activates defense mechanisms such as local acquired resistance (LAR) and systemic acquired resistance (SAR). This acquired resistance plays a pivotal role in regulating stress responses and plant developmental processes including heat production or thermogenesis, photosynthesis, stomatal conductance, transpiration, ion uptake, and transport, disease resistance, seed germination, sex polarization, crop yield, and glycolysis. These signal molecules act as a plant stress response, both biotic and abiotic types, including wounding, pathogens/insects, mechanical, drought, and chilling injury (CI).

Nanoencapsulation:

The product uses nanoencapsulation to create sustained the first-order release of the active ingredients near the produce. Plant polymers are used to effectively create exterior shell-type encapsulation to create a controlled release of the active ingredients. Precise use of nanoencapsulation helps with customizing the product for any stakeholder.

Product Formulation:

The composition essentially comprises an active ingredient and an encapsulation shell. Active Ingredients are selected from Phenolic compounds such as Salicylic acid, Methyl Salicylate, Methyl Jasmonate, Gibberellic acid, Brassinosteroid. Encapsulation Shell is selected from proteins or polymers such as Gamma/Beta/alpha-cyclodextrin. PLA, inulin, etc.

The product is also made available in the form of a kit, according to this invention the KIT comprises of compositions to extend the shelf life of the produce desired. The kit, therefore, comprises a large container containing various smaller containers or sachets containing the active ingredients in the predetermined volume, and advantageously, and optionally, an explanatory brochure including useful information for mixing or using the composition.

When introducing elements disclosed herein, the articles “a”, “an”, “the”, and “said” are intended to mean that there are one or more of the elements unless the context dictates otherwise. For example, the term “a compound” and “at least one compound” may include a plurality of compounds, including mixtures thereof.

The terms “comprising”, “having”, “including” are intended to be open-ended and mean that there may be additional elements other than the listed elements. As is understood by the skilled person, the application of the composition can be done in a variety of manners. For example, using a sprayer, using a sachet for a gradual release of the composition, or crate or container designed to release the composition towards the goods stored in it, or any other method of exposing the agricultural produce to the composition of this invention for extending its shelf life.

Before describing the present invention in detail, it is to be understood that this invention is not limited to particularly exemplified systems or process parameters that may, of course, vary. It is also to be understood that the terminology used herein is for the purpose of describing particular embodiments of the invention only and is not intended to limit the scope of the invention in any manner

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The principal embodiment of this invention is a composition for activating a plant's natural defense mechanisms to extend the shelf life of its produce and preserve its quality; by slowing down the ethylene biosynthesis pathway and restricting the microbial growth on it.

Another embodiment of this invention is the composition essentially comprises of an active ingredient and an encapsulation shell.

Yet another embodiment of this invention is the active ingredients are selected from Phenolic compounds such as Salicylic acid, Methyl Salicylate, Methyl Jasmonate, Gibberellic acid, Brassinosteroid.

In yet another embodiment of the invention, the encapsulation Shell is selected from proteins and polymers such as Beta/alpha-cyclodextrin. PLA.

A further embodiment of this invention is the methyl salicylate is in the range of 1.0 to 3.5 ml per liter of composition.

Other embodiment of this invention is the Beta Cyclodextrin is in the range of 11 to 30 grams per liter of the composition.

As a further embodiment of this invention, the solvent used to make up the composition into 1 liter is water.

In yet another embodiment of this invention, a method for extending the shelf life of agricultural produce; comprising the steps of
a. Collecting the agricultural produce in the desired storage container,
b. Exposing said agricultural produce to an active ingredient composition, and
c. Shelving the Agricultural produce for transport or later use.

Another embodiment of this invention is the agricultural produce includes are greens, fruits, cereals, flowers, vegetables, etc.

A further embodiment of this invention is the active ingredient is exposed to agricultural produce by any of the following means;
d. Placing a sachet of composition in the middle of the produce for gradual release,
e. Spraying the composition over the produce,
f. By dipping the whole produce in the composition,
g. Crates or containers pre-coated with composition,
h. Foils or papers, pre-coated with composition for covering produce or flowers.

As a final embodiment, the composition is in the form of a kit comprising the ingredients of the composition in separate containers or premixed in a single container, optionally with a user manual for effective handling of the kit.

This cost-effective, simple method of extending the shelf life of the Agricultural produce by using this novel formulation is illustrated by the following non-limiting examples.

### Working Examples

The plant defense mechanism, plant physiology and climatic data of each fruit is studied before starting the formulation. A particulate pathway is selected, and a potential volatile signal molecule (active ingredient) is selected. A particular concentration of the active material is selected and the encapsulation process with a plant polymer is completed.

### Example 1: formulation for Figs

Methyl Salicylate and Beta Cyclodextrin Encapsulation Formulation:

The ratio between Beta Cyclodextrin and Methyl Salicylate=1:1
i. Concentration of Methyl Salicylate=25 mM/L
   Mass (mg)=Conc (mM/L)*Volume (L)*Molecular Weight (g/mol)
   Mass (g)=3.803 g in 1 L
   Volume (ml)=Mass (g)/Density
   Volume (ml)=3.239 mL in 1 L
ii. Concentration of Beta Cyclodextrin=25 mM/L
   Mass (g)=28.375 g in 1 L
iii. The formulation:
   Water=1 L
   Methyl Salicylate=3.239 ml
   Beta Cyclodextrin=28.375 g
iv. Encapsulation process:

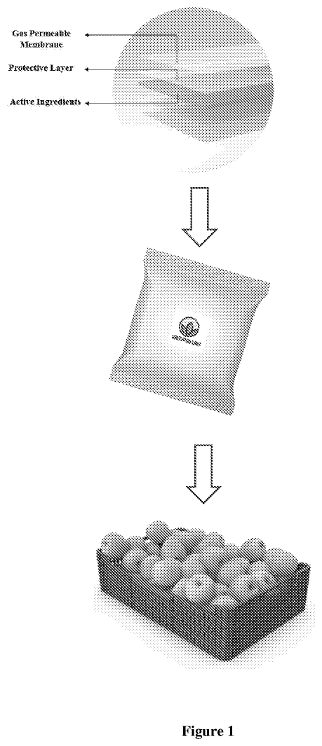

The nano-emulsion is developed by mixing Methyl salicylate oil, water, and beta-cyclodextrin. The emulsion is then dried at 60*C to form nano-encapsulates. Those nano-encapsulates are then packed in a sachet or used for dip treatment
a. Sachet: 5 grams formed nano-encapsulates are packed in a sachet (preferably made in a non-woven fabric) and are placed near 1 Kg of fig samples (FIG. 1)
b. Dip Treatment: 1.5 gram formed nano-encapsulates are dissolved in water and 1 Kg of fig samples are dipped inside the water and later dried.

### Example 2: Analysis of FIG Trial Results

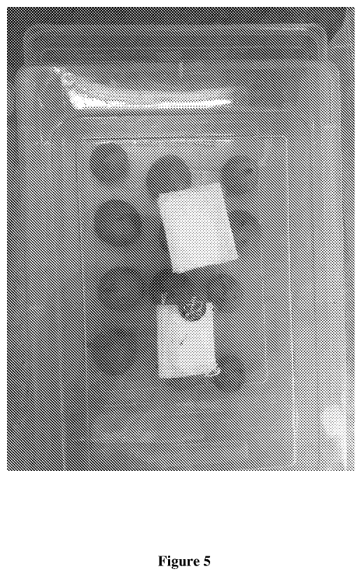

Common green mission variety figs are used in this experiment. Relatively uniform sized fruits free from any damages, pests, and diseases are selected. The test samples and control samples were placed inside a 5 L plastic container as in FIG. 5.

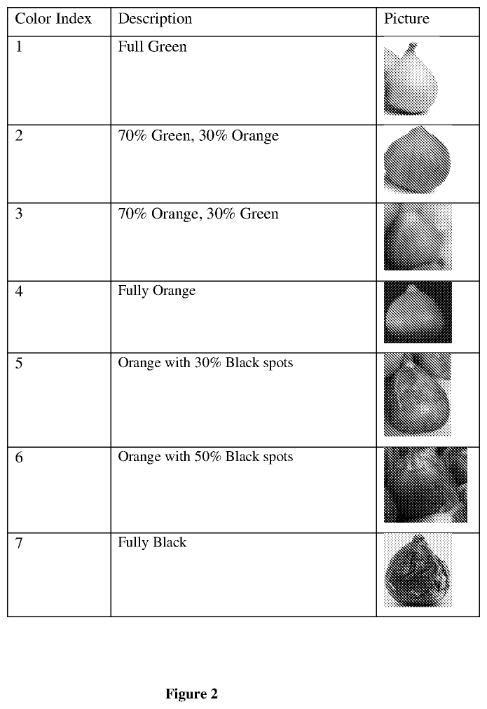

Qualitative analysis such as decay index, color change index, and physiological weight loss % were measured to evaluate the effectiveness of the active packaging formulation.
a) Colour Change Index:
   The color of the crop every day was compared with the maturity color chart (FIG. 2). The color index for each fruit in different treatments are tracked throughout the fruit's shelf life. A color index above 4 is not acceptable for consumption.
b) Decay Index:
   The degree of decay index in fruits was indicated based on external damage on the skin. The decay score was assessed by the percentage of total surface area affected, where;
      0=no visible decay area,
      1=1-10% decay area,
      2=11-25% decay area,
      3=26-50% decay area,
      4=51-75% decay area, and
      5=>75% decay area.
   It is calculated by using the formula;

$$Decay Index = \frac{Total s core of decay on fruits}{[ Number of fruits observed * Maximum score ]} \%$$

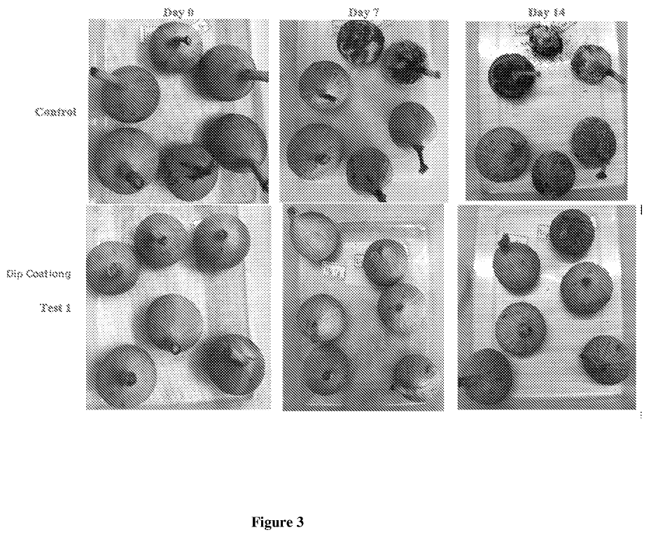

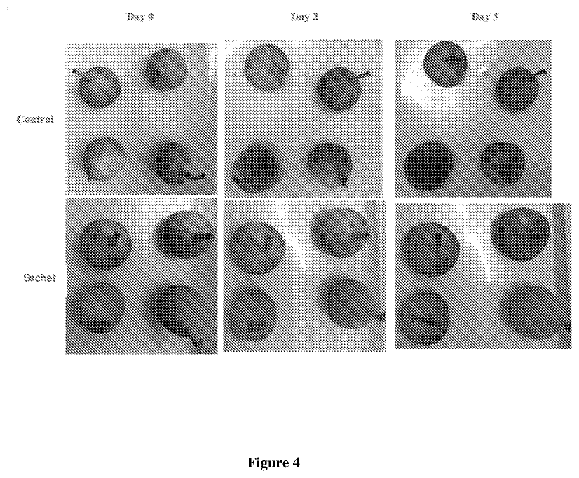

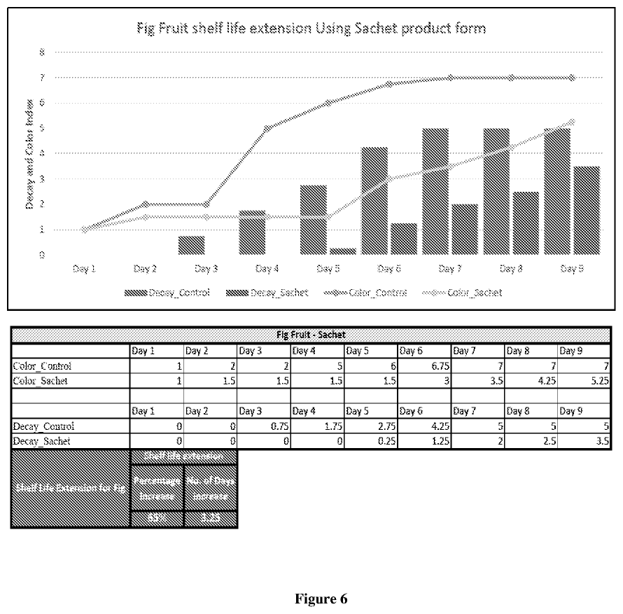

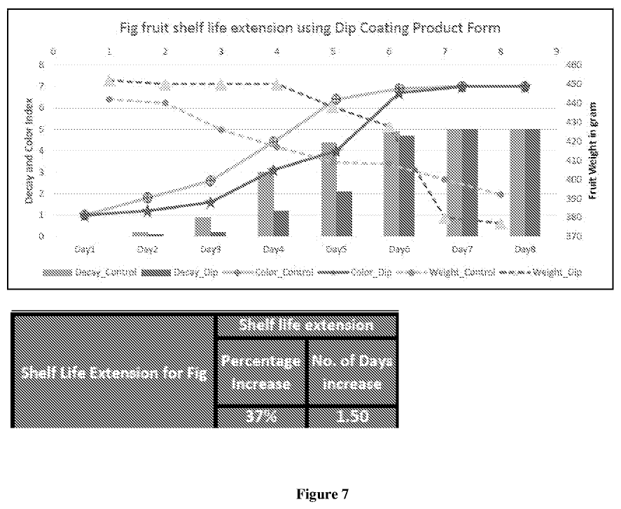

A decay index of more than 3 is not acceptable for consumption.
c) Physiological weight loss %:
   The cumulative weight of the fruits in each box is recorded throughout the shelf life period.
   It is observed that the fruits exposed to the formulation are having increased shelf life (FIGS. 3 and 4) in comparison to the unexposed ones.
d) In the fig fruits exposed to sachet form of formulation
   The results are tabulated as in FIG. 6 and the shelf life is extended by 3.25 days i.e. 65% more in comparison to the unexposed fruits
e) In the fruits exposed to formulation by dipping in the formulation
   The results are tabulated as in FIG. 7 and the shelf life is extended by 1.5 days i.e 37% more in comparison to the undipped fruits

### Example 3: formulation for Pomegranate

The ratio between Beta Cyclodextrin and Methyl Salicylate=1:1

Methyl Salicylate and Beta Cyclodextrin Encapsulation Formulation:
i. Concentration of Methyl Salicylate=10 mM/L
   Mass (mg)=Conc (mM/L)*Volume (L)*Molecular Weight (g/mol)
   Mass (g)=1.521 g in 1 L
   Volume (ml)=Mass (g)/Density
   Volume (ml)=1.295 mL in 1 L
ii. Concentration of Beta Cyclodextrin=25 mM/L
   Mass (g)=11.35 g in 1 L
iii. Actual formulation:
   Water=1 L
   Methyl Salicylate=1.295 ml
   Beta Cyclodextrin=11.35 g

### Example 4: Pomegranate Trial Analysis

Relatively uniform sized fruits free from any damages, pest, and diseases were chosen. The test samples and control samples were placed inside a 5 L plastic container.

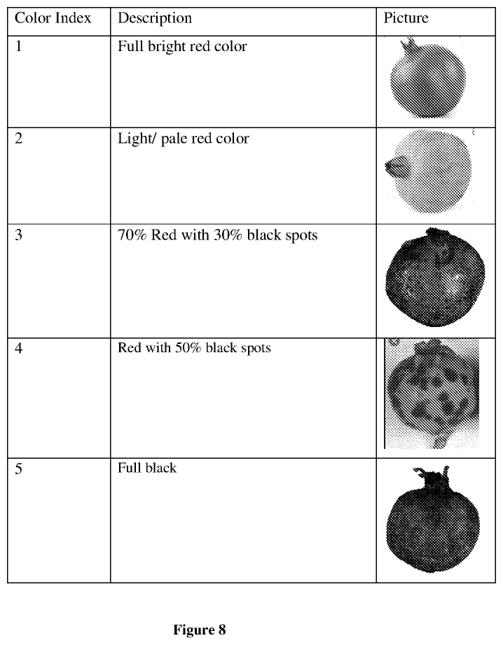

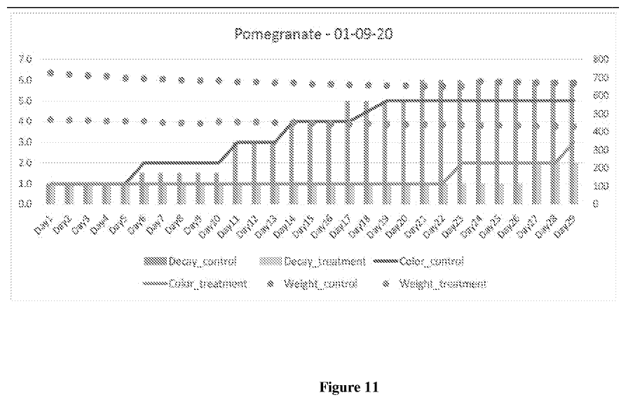

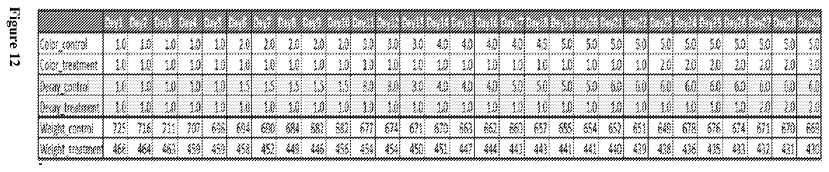

Qualitative analysis such as decay index, color change index, and physiological weight loss % were measured to evaluate the effectiveness of the active packaging formulation.
a) Colour Change Index:
   The color of the crop every day was compared with the maturity color chart (FIG. 8). The color index for each fruit in different treatments (dip or Sachet) are tracked throughout the fruit's shelf life and results are noted (FIGS. 11 and 12). A color index above 3 is not acceptable for consumption.
b) Decay Index:
   The degree of decay index in fruits was indicated based on external damage on the skin. The decay score was assessed by the percentage of total surface area affected, where
   0=no visible decay area,
   1=1-10% decay area,
   2=11-25% decay area,
   3=26-50% decay area,
   4=51-75% decay area, and
   5=>75% decay area.
   It is calculated by using the formula given below.

$$Decay Index = \frac{Total s core of decay on fruits}{[ Number of fruits observed * Maximum score ]} \%$$

A decay index of more than 3 is not acceptable for consumption.
c) Physiological weight loss %:
   The cumulative weight of the fruits in each box were recorded throughout the shelf life period.

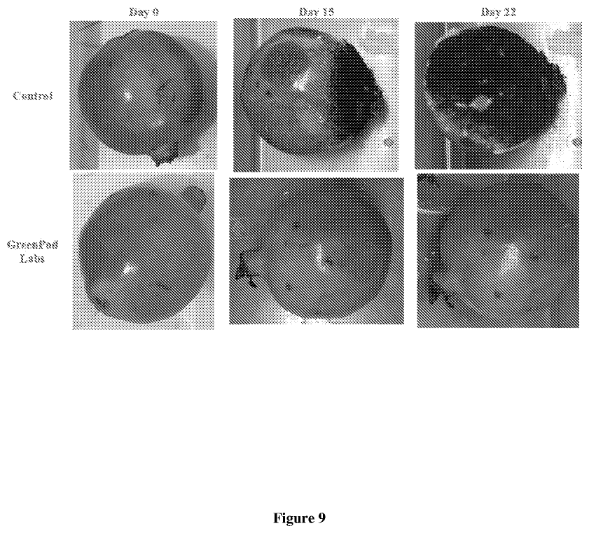

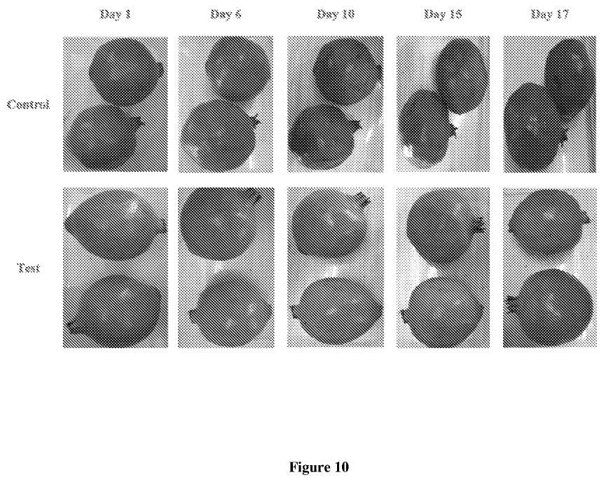

It is observed that the fruits exposed to the formulation are having increased shelf life of 18 days i.e., 190% more (FIGS. 9 and 10) in comparison to the unexposed ones.

### Example 5: formulation for Tomatoes

Ratio between Beta Cyclodextrin and Methyl Salicylate=1:1

Methyl Salicylate and Beta Cyclodextrin Encapsulation Formulation:
i. Concentration of Methyl Salicylate=12.5 mM/L
   Mass (mg)=Conc (mM/L)*Volume (L)*Molecular Weight (g/mol)
   Mass (g)=1.9015 g in 1 L
   Volume (ml)=Mass (g)/Density
   Volume (ml)=1.6195 mL in 1 L
ii. Concentration of Beta Cyclodextrin=25 mM/L
   Mass (g)=14.1875 g in 1 L
iii. Actual formulation:
   Water=1 L
   Methyl Salicylate=1.6195 ml
   Beta Cyclodextrin=14.1875 g

### Example 6: Tomatoes Trial Analysis

Relatively uniform sized tomato fruits free from any damages, pest, and diseases were chosen. The test samples and control samples were placed inside a 5 L plastic container.

Qualitative analysis such as decay index, color change index, and physiological weight loss % were measured to evaluate the effectiveness of the active packaging formulation.
a) Colour Change Index:
   The color of the fruit every day was compared with the maturity color chart. The color index for each fruit in different treatments are tracked throughout the fruit's shelf life. A color index above 3 is not acceptable for consumption.
b) Decay Index:
   The degree of decay index in fruits was indicated based on external damage on the skin. The decay score was assessed by the percentage of total surface area affected, where
   0=no visible decay area,
   1=1-10% decay area,
   2=11-25% decay area,
   3=26-50% decay area,
   4=51-75% decay area, and
   5=>75% decay area.
   It is calculated by using the formula given below.

$$Decay Index = \frac{Total s core of decay on fruits}{[ Number of fruits observed * Maximum score ]} \%$$

A decay index of more than 3 is not acceptable for consumption.
c) Physiological weight loss %:

The cumulative weight of the fruits in each box were recorded throughout the shelf life period.

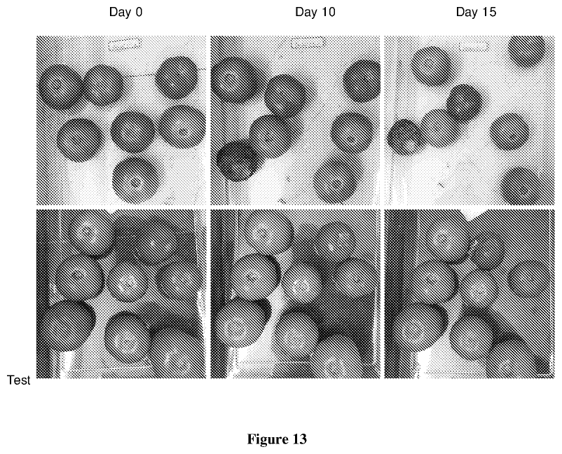

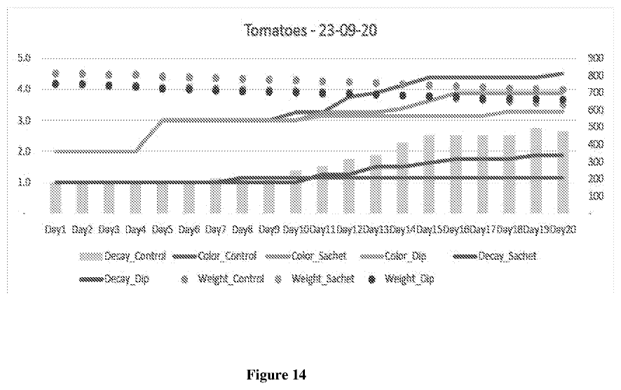

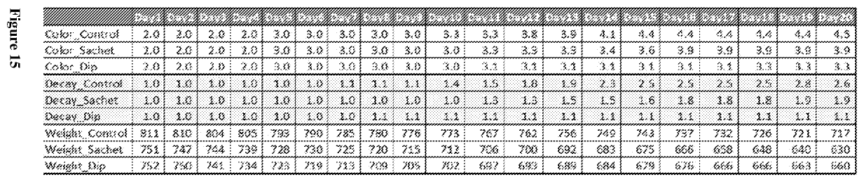

It is observed (FIGS. 13 and 14) the fruits exposed to the formulation are having more shelf life than the unexposed ones.

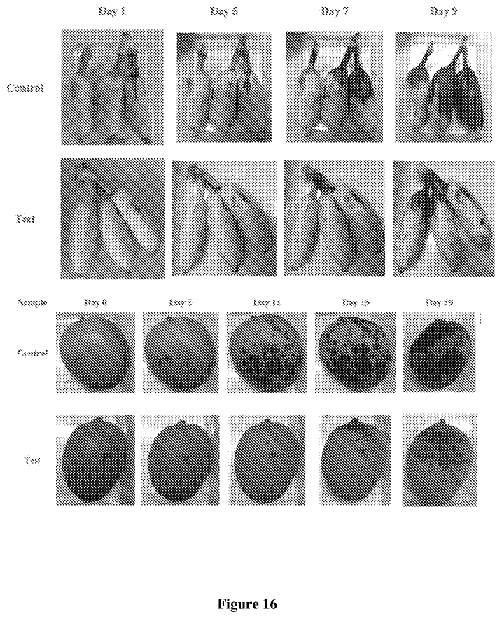

In Sachets form, the tomatoes life is extended by 7 days (45%) more and by dipping in the formulation also the Shelf life is extended by the same number of days as sachets exposure method. The results observed are tabulated and annexed as FIG. 15.

### Example 7: Formulation for Red Roses

Methyl Salicylate and Beta Cyclodextrin Encapsulation Formulation:
i. Concentration of Methyl Salicylate=5 mM/L
   Mass (mg)=Conc (mM/L)*Volume (L)*Molecular Weight (g/mol)
   Mass (g)=0.7605 g in 1 L
   Volume (ml)=Mass (g)/Density
   Volume (ml)=0.648 mL in 1 L
ii. Concentration of Beta Cyclodextrin=5 mM/L
   Mass (g)=5.675 g in 1 L
iii. Actual formulation:
   Water=1 L
   Methyl Salicylate=0.648 ml
   Beta Cyclodextrin=5.675 g

Salability is essentially based on the Shelf life of the flowers. The more the shelf life, the more saleable the produce will be. To characterize the salability of flowers, two characters are important, the petal colourization and its turgescence.
Petal Colorization
   1-Without Darkening
   2-Light Darkening (<20%)
   3-Moderate Darkening (20-60%)
   4-Intense Darkening (>60%)
Turgescence
   1-Turgid
   2-Slightly Wilted (<30%)
   3-Fully Wilted (>30%)

### Example 8: Analysis of Red Rose Trial Results

The salability of the Flower is up to a color index of 2. Similarly, the salability of the flower reduces after reaching a turgescence index of 2.

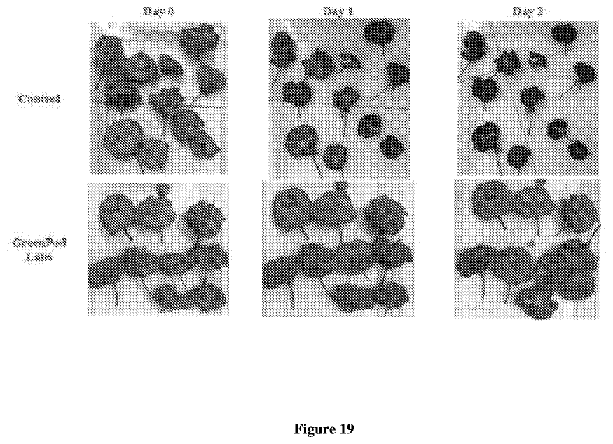

The results observed from the trial are tabulated below and a graphical illustration of the collected data is made in FIG. 18. The vertical axis on the left is a common indicator for both the Colour and Turgescence Index. The following table depicts the colour retention and turgescence values observed in the red roses.

| | Day 1 | Day 2 | Day 3 | Day 4 | Day 5 |
|---|---|---|---|---|---|
| Colour -Control | 1 | 3 | 3 | 3 | 3 |
| Colour- test sample | 1 | 1.3 | 1.3 | 1.3 | 1.5 |
| Turgescence - Control | 1 | 2.0 | 3.0 | 3.0 | 3.0 |
| Turgescence - Test | 1 | 1.1 | 1.2 | 1.2 | 1.5 |

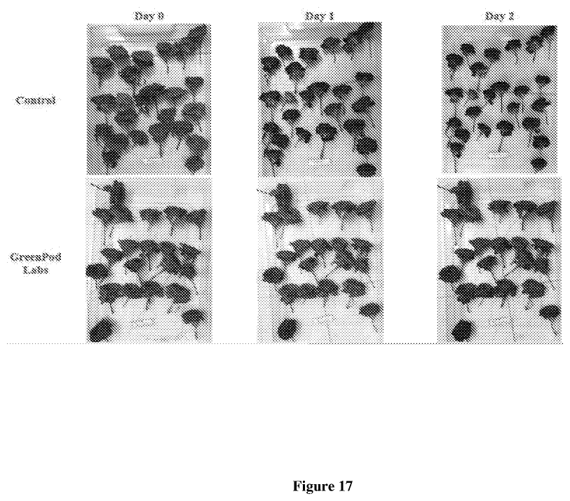

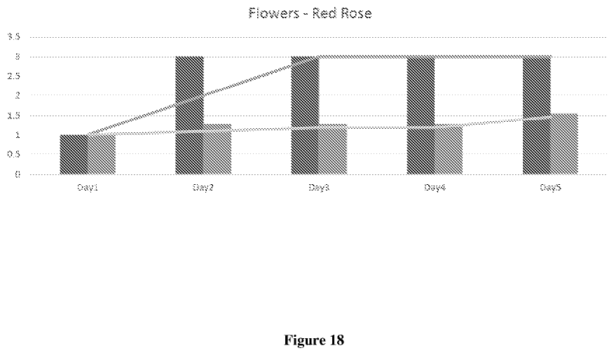

The results clearly indicate the shelf life of the flowers got extended by 60% i.e., 02 days. The pictures of the red roses during this trial are captured and annexed (FIG. 17).

### Example 9: Pink Roses Paneer Roses

Methyl Salicylate and Beta Cyclodextrin Encapsulation Formulation:
i. Concentration of Methyl Salicylate=5 mM/L
   Mass (mg)=Conc (mM/L)*Volume (L)*Molecular Weight (g/mol)
   Mass (g)=0.7605 g in 1 L
   Volume (ml)=Mass (g)/Density
   Volume (ml)=0.648 mL in 1 L
ii. Concentration of Beta Cyclodextrin=5 mM/L
   Mass (g)=5.675 g in 1 L
iii. Actual formulation:
   Water=1 L
   Methyl Salicylate=0.648 ml
   Beta Cyclodextrin=5.675 g

Similar to Red rose, to characterize the salability of the pink rose, two characters are important, the petal colourization and its turgescence.
Petal Colorization
   1-Without Darkening
   2-Light Darkening (<20%)
   3-Moderate Darkening (20-60%)
   4-Intense Darkening (>60%)
Turgescence
   1-Turgid
   2-Slightly Wilted (<30%)
   3-Fully Wilted (>30%)

### Example 10: Analysis of Pink Rose Trial Results

The salability of the Flower is up to a color index of 2. Similarly, the salability of the flower reduces after reaching a turgescence index of 2.

The results observed from the trial are tabulated below and a graphical illustration of the collected data is made in FIG. 20. The vertical axis on the left is a common indicator for both the Color and Turgescence Index. The following table depicts the color retention and turgescence values observed in the red roses.

| | Day 1 | Day 2 | Day 3 | Day 4 | Day 5 |
|---|---|---|---|---|---|
| Colour -Control | 1 | 3 | 3 | 3 | 3 |
| Colour- test sample | 1 | 1.0 | 1.0 | 1.0 | 1.3 |
| Turgescence - Control | 1 | 2.0 | 3.0 | 3.0 | 3.0 |
| Turgescence - Test | 1 | 1.0 | 1.0 | 1.0 | 1.3 |

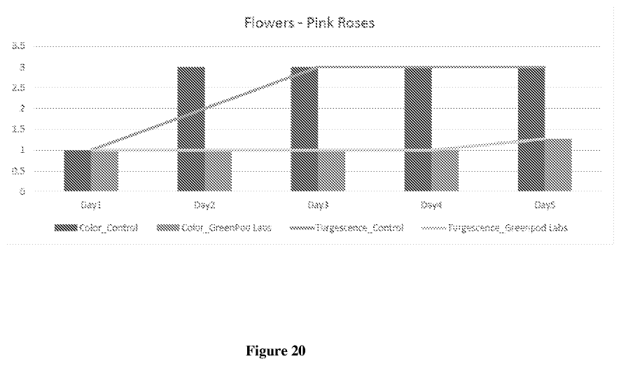

The results clearly indicate the shelf life of the flowers got extended by 60% i.e., 02 days. The pictures of the pink roses during this trial are captured and annexed (FIG. 19).

### Example 11: KIT

The product is made in the form of a kit for ease of end-user. The KIT comprises of compositions to extend the shelf life of the produce desired. The kit, therefore, comprises a large container containing various smaller containers or sachets with active ingredients in a pre-determined volume, and optionally, an explanatory brochure including useful information for mixing or using the composition.

Advantages

This composition has the following advantages over conventional methods.
a) The active compounds in the composition preserve the quality and extend the shelf life of flowers, fruits, and vegetables. The product uses the activation of the plant's natural defense mechanisms as the science behind its function. This mechanism is not been commercialized in the market yet. This mechanism targets the root cause to extend the shelf life of the fresh produce and preserve its quality. Other active packaging solutions in the market control the external environment rather than controlling biochemistry responsible for the fruit ripening/spoilage.
b) A significantly cost-effective solution that could be adopted throughout the supply chain. This solution when compared with other solutions such as cold-storage in the market is extremely cost-effective and provides functionality better than the cold-storage.
c) This innovation can be customized as per the stakeholder needs and for individual flowers or fruit or vegetables. A predictive data model is been built which includes the plant physiology data such as respiration rate, ethylene production rate, transpiration rate, and included climatic data such as temperature, relative humidity, etc. This data model would help in effectively predicting the product concentration needed for different fruit.
d) Easy to scale solution specifically developed for the Indian market. The use of nanotechnology and an effective manufacturing process would help with the easy scale-up of this solution compared to other solutions in the market.

1. A composition for activating plant's natural defense mechanisms to extend the shelf life of its produce and preserve its quality; by slowing down the ethylene biosynthesis pathway and restricting the microbial growth on it.

2. The composition as claimed in claim 1, wherein said composition essentially comprises of an active ingredient and an encapsulation shell.

3. The composition as claimed in claim 2, wherein the active ingredient is a phenolic compound.

4. The composition as claimed in claim 2, wherein said encapsulation shell is selected from the group consisting of proteins and polymers.

5. The composition as claimed in claim 12, wherein the methyl salicylate is in the range of 1.0 to 3.5 ml per liter of composition.

6. The composition as claimed in claim 13, wherein the beta cyclodextrin is in the range of 11 to 30 grams per liter of the composition.

7. The composition of claim 5, wherein the solvent used to make up the composition into 1 liter is water.

8. A smart packaging method for extending the shelf life of agricultural produce; comprising the steps of
a) collecting the agricultural produce in the desired storage container,
b) exposing said agricultural produce to an active ingredient composition of claim 1, and
c) shelving the agricultural produce for transport or later use.

9. The method as claimed in claim 8, wherein said agricultural produce are greens, fruits, flowers, and vegetables.

10. The method as claimed in claim 1, wherein the active ingredient is exposed to agricultural produce by any of the following means;
a) placing a sachet of composition in the middle of the produce for gradual release,
b) spraying the composition over the produce,
c) by dipping the whole produce in the composition,
d) crates or containers pre-coated with composition,
e) foils or papers, pre coated with composition for covering produces or flowers.

11. The composition as claimed in claim 1, is in the form of a kit comprising the ingredients of the composition in separate containers or premixed in a single container, optionally with a user manual for effective handling of the kit.

12. The composition as claimed in claim 3, wherein the phenolic compound is selected from the group consisting of salicylic acid, methyl salicylate, methyl jasmonate, gibberellic acid, and brassinosteroid.

13. The composition as claimed in claim 4, wherein the polymer is selected from the group consisting of beta/alpha-cyclodextrin and PLA.

14. The composition of claim 6, wherein the solvent used to make up the composition into 1 liter is water.
